(19) United States
(12) Patent Application Publication
(10) Pub. No.: US 2015/0365202 A1
(43) Pub. Date: Dec. 17, 2015

(54) COMMUNICATION APPARATUS AND COMMUNICATION METHOD

(71) Applicant: Kabushiki Kaisha Toshiba, Minato-Ku (JP)

(72) Inventors: Hiroki Kudo, Kawasaki (JP); Masahiro Ishiyama, Kawasaki (JP); Kenichi Maeda, Kamakura (JP); Arata Miyamoto, Kita (JP); Hiroto Nakai, Yokohama (JP)

(73) Assignee: Kabushiki Kaisha Toshiba, Minato-ku (JP)

(21) Appl. No.: 14/483,638

(22) Filed: Sep. 11, 2014

Related U.S. Application Data
(60) Provisional application No. 62/013,291, filed on Jun. 17, 2014.

(51) Int. Cl. H04L 5/00; H04L 12/18

(52) U.S. Cl. CPC H04L 5/006; H04L 12/189

(57) ABSTRACT

According to one embodiment, a communication apparatus includes an operation mode storage unit configured to store whether the communication apparatus is in a mode to operate as a radio base station or a mode to operate as a terminal, and a non-volatile memory. In a case of the radio base station, a message to be transmitted is output to the outside. In a case of the terminal, data included in a received message is stored in the non-volatile memory. In a case of operating as the radio base station, the operation mode is changed from the terminal to the radio base station when communication quality with an external first radio base station is less than a predetermined value and a message from a radio base station other than the first radio base station is not received after all the data transmitted by the first radio base station have been received.

### CROSS-REFERENCE TO RELATED APPLICATIONS

This application is based upon and claims the benefit of priority from U.S. Provisional Application No. 62/013,291, filed on Jun. 17, 2014; the entire contents of which are incorporated herein by reference.

### FIELD

Embodiments described herein relate generally to a communication apparatus and a communication method.

### BACKGROUND

There has been a system for communication via a radio base station in wireless communication. In this communication, terminals do not directly communicate with each other. In such a system, the radio base station transmits a notification signal in which information for wireless connection has been stored, and the terminal performs processing for connecting with the radio base station based on the notification signal received from the radio base station.

### BRIEF DESCRIPTION OF THE DRAWINGS

FIG. 1 is a block diagram of an exemplary configuration of a communication apparatus according to an embodiment;

FIG. 2 is a diagram of exemplary message transmission according to the embodiment;

FIG. 3 is a diagram of an exemplary configuration of a first notification signal according to the embodiment;

FIG. 4 is a diagram of an exemplary procedure involved in state transition of a subscriber;

FIG. 5 is a flowchart of an exemplary determination procedure for mode switching;

FIG. 6 is a diagram of an exemplary procedure for switching a mode to a radio base station in a case of complying with IEEE 802.11;

FIG. 7 is a diagram of an exemplary mode switching to the radio base station in a case where there is a plurality of terminals;

FIG. 8 is a diagram for describing “waiting” of a first switching waiting time and a second switching waiting time;

FIG. 9 is a diagram of an exemplary procedure for participating in a multicast group;

FIG. 10 is a diagram of an exemplary configuration of a second notification signal according to the embodiment;

FIG. 11 is a diagram of an exemplary configuration of a multicast data message; and

FIG. 12 is a diagram of an exemplary state transition according to the embodiment.

### DETAILED DESCRIPTION

In general, according to one embodiment, a communication apparatus of the present embodiment stores a mode of either a publisher or a subscriber and stores a first identifier indicating that the communication apparatus belongs to a first group. In a case of the publisher, a message to be transmitted including ToC information which is a list of the first identifier and data to be transmitted is transmitted outside. In a case of the subscriber, data included in the message is stored in a non-volatile memory when a received message includes the first identifier. When it has been determined that all the data of the ToC information stored in the received message have been received, and when a first communication quality in communication with the connected publisher is less than a first threshold and there is no publisher other than the connected publisher, the mode is changed to the publisher.

Exemplary embodiments of a communication apparatus and a communication method will be explained below in detail with reference to the accompanying drawings. The present invention is not limited to the following embodiments.

### Embodiment

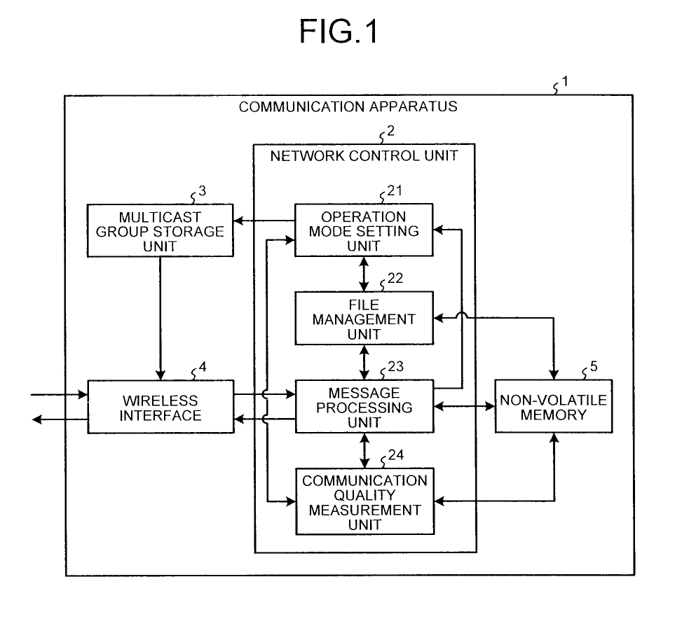

FIG. 1 is a block diagram of an exemplary configuration of a communication apparatus 1 according to the embodiment. The communication apparatus 1 includes a network control unit 2, a multicast group storage unit 3 (identification information storage unit), a wireless interface 4, and a non-volatile memory 5.

The communication apparatus 1 according to the present embodiment can transmit/receive data to/from another communication apparatus 1 with the same configuration via Peer-to-Peer (P2P) communication. The communication apparatus 1 can perform unicast communication with another communication apparatus 1 and transmit the same data to a plurality of other communication apparatuses 1 via multicast communication.

The wireless interface 4 performs reception processing of a wireless signal. When the received signal is a message sent to the communication apparatus 1, the wireless interface 4 outputs the message to the network control unit 2. Also, the wireless interface 4 transmits a message generated by the network control unit 2 as the wireless signal. Further, the wireless interface 4 performs transfer processing to realize the P2P communication by the plurality of communication apparatuses 1. There is no restriction on a protocol or the like to realize the P2P communication. For example, Internet Protocol (IP) can be used.

The multicast group storage unit 3 with a configuration to be described below, in which a publisher transmits the data via the multicast, holds a list of identifiers of multicast groups to which the communication apparatus 1 belongs. The multicast group storage unit 3 informs the wireless interface 4 of the identifier of the multicast group to which the communication apparatus 1 belongs. The wireless interface 4 determines that a message, in which a multicast address corresponding to the identifier of the multicast group to which the communication apparatus 1 belongs is stored in an address, is also sent to the communication apparatus 1. The non-volatile memory 5 holds data to be transmitted, received data, and the like. The network control unit 2 includes an operation mode setting unit 21, a file management unit 22, a message processing unit 23, and a communication quality measurement unit 24.

The operation mode setting unit 21 (operation mode storage unit) of the network control unit 2 stores whether a mode of the communication apparatus 1 is a mode to operate as a radio base station (radio base station mode) or a mode to operate as a terminal (terminal mode). In the present embodiment, the terminal can be the radio base station, and the radio base station can be the terminal.

With the configuration to be described below in which the publisher transmits the data via the multicast, the operation mode setting unit 21 also sets the multicast group to which the communication apparatus 1 belongs. In a case where the radio base station transmits the data via the multicast as the publisher, the operation mode setting unit 21 also stores that the mode of the communication apparatus 1 is either the publisher or the subscriber. With a configuration to be described below in which the publisher distributes a file to the subscriber via the multicast, generally, the publisher operates as the radio base station and the subscriber operates as the terminal. However, the publisher may operate as the terminal, and the subscriber may operate as the radio base station. The setting of the multicast group will be described below. The operation mode setting unit 21 manages switching processing from the terminal to the radio base station and switching processing from the radio base station to the terminal. In a case where the communication apparatus 1 transmits the data via the multicast as the publisher, the operation mode can be individually set for each multicast group. For example, a single communication apparatus 1 may be the publisher in one multicast group and may be the subscriber in another multicast group. The operation mode setting unit 21 controls the file management unit 22 and the message processing unit 23 so as to perform an operation according to the operation mode for each multicast group.

The message processing unit 23 generates a message in which the data to be transmitted to the other communication apparatus 1 is formed in a certain format and transmits the message to the wireless interface 4. Also, the wireless interface 4 receives a message from the other communication apparatus 1 and performs processing according to contents of the message. The message processing unit 23 stores the data in the non-volatile memory 5 when the received message is a data message in which predetermined data is stored.

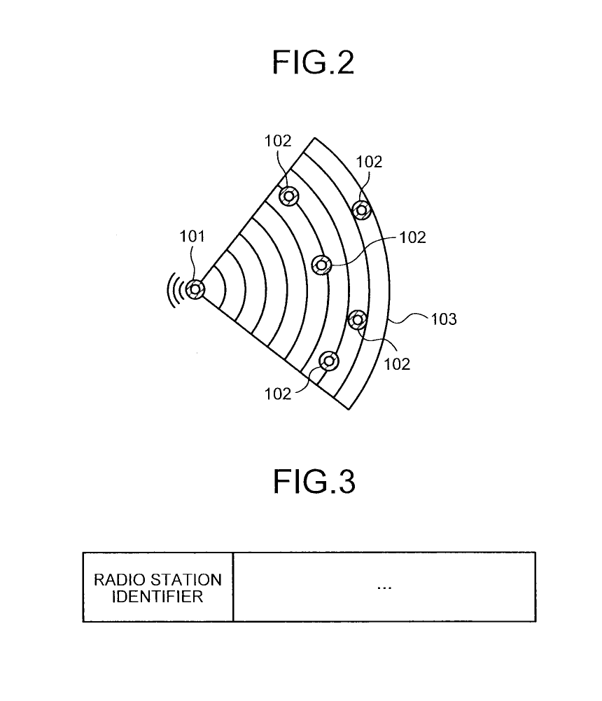

FIG. 2 is a diagram of exemplary message transmission according to the present embodiment. A situation is illustrated where a radio base station 101 (communication apparatus 1 operating as the radio base station) transmits the data message in which the predetermined data is stored via the multicast. A terminal 102 located in a reachable range 103 of radio waves from the radio base station 101 can receive the data message. The radio waves output from the radio base station 101/terminal 102 may have directionality or may have no directionality. When the radio waves have no directionality, the radio waves output from the radio base station 101/terminal 102 concentrically propagate in a free space in FIG. 2.

FIG. 3 is an exemplary configuration of a first notification signal according to the present embodiment. The first notification signal is a notification signal transmitted from the radio base station. For example, a radio station identifier relevant to wireless connection of the radio base station is stored in the first notification signal as indicated in FIG. 3. As the radio station identifier, for example, a service set identifier (SSID) in a beacon frame of a wireless local area network (LAN) and the like can be used. The first notification signal may include information other than the radio station identifier. There is no restriction on a configuration of the first notification signal. For example, a beacon frame in the wireless local area network (LAN) can be used as the first notification signal.

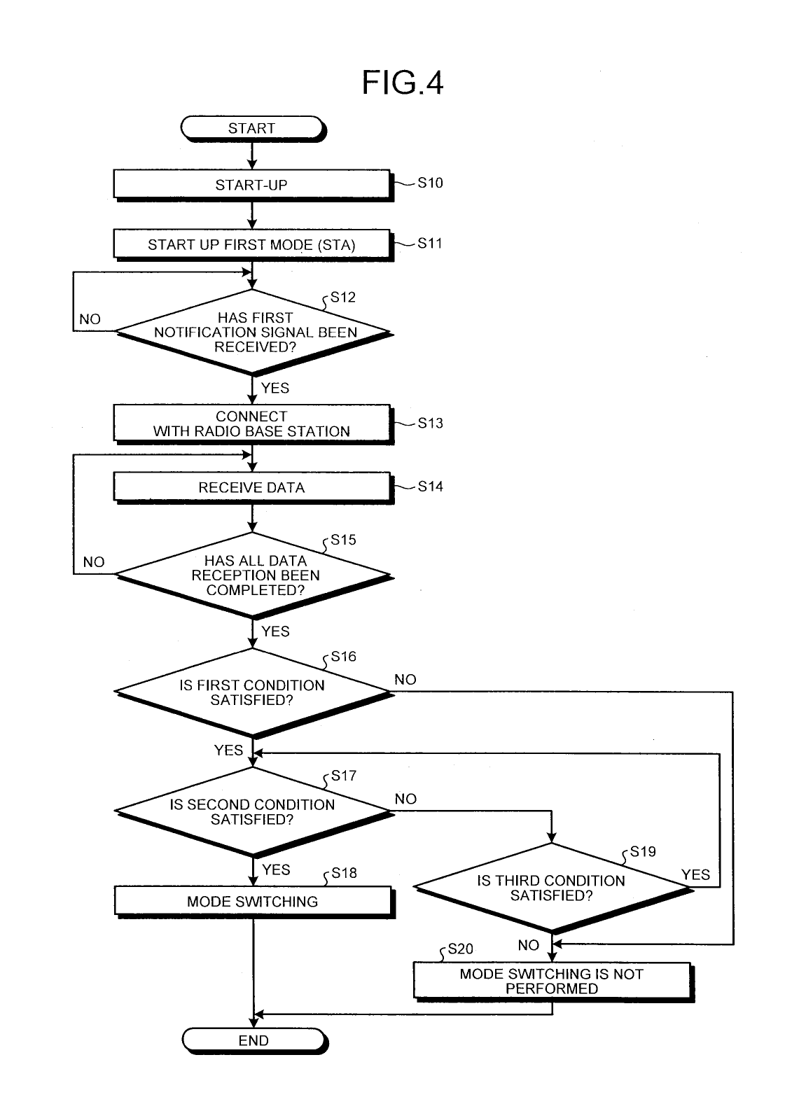

FIG. 4 is a diagram of an exemplary procedure according to a case of state transition in which a mode of the communication apparatus of the embodiment to operate as the terminal (station, STA) is changed to a mode to operate as the radio base station (access point, AP). When turned on (step S10), the communication apparatus starts an operation in the mode to operate as the terminal (step S11) as indicated in FIG. 4. It is determined whether the first notification signal from the radio base station has been received (step S12). When the first notification signal has been received (Yes in step S12), the terminal send the association request message to the radio base station, then connection between the terminal and the base station has been established (step S13). When the first notification signal has not been received (No in step S12), step S12 is repeated.

The communication apparatus 1 in the mode to operate as the terminal connected to the radio base station receives predetermined data (step S14). The communication apparatus 1 determines whether all the data have been received (step S15). Specifically, in a case of the configuration described above in which the publisher distributes the file to the subscriber via the multicast, the file management unit 22 determines whether the communication apparatus has all the files corresponding to the ToC (file having a possibility to be distributed from the publisher) based on table of contents (ToC) information (content information) to be described below informed by a second notification signal. In accordance with the determination, it is determined whether all the data have been received. When all the data have been received, the communication apparatus 1 starts the mode switching from the mode to operate as the terminal to the mode to operate as the radio base station.

As a condition to determine that all the data have been received, a method to determine according to whether all the corresponding files are included based on the ToC information is the most effective method in the present invention as described above in the configuration in which the publisher distributes the file to the subscriber via the multicast. Instead of whether all the files have been received, a fact that the files have been received a predetermined number of times or an elapsed time from the time when the reception has been started may be a trigger to determine that all the data have been received. The reception of control data to inform that all the data have been received may also be the trigger.

The condition determination is made in processing equal to or higher than the network layer of open systems interconnection (OSI) reference model in the above-mentioned method. However, in a case where the communication apparatus operates as the radio base station or the terminal, the number of times of receiving the first notification signal in the data link layer or the elapsed time from the time when the reception has been started may be a trigger.

The procedure returns to step S14 when all the data have not been received (No in step S15). When all the data have been received (Yes in step S15), the operation mode setting unit 21 determines whether a first condition is satisfied (step S16). The first condition will be described below. When the first condition has been satisfied (Yes in step S16), the operation mode setting unit 21 determines whether a second condition is satisfied (step S17). The second condition will be described below. When the second condition has been satisfied (Yes in step S17), the mode is switched and changed to the mode to operate as the radio base station (step S18). When the second condition has not been satisfied (No in step S17), it is determined whether a third condition is satisfied (step S19). When the third condition is satisfied (Yes in step S19), the procedure returns to step S17.

In a case where the first condition is not satisfied in step S16 (Yes in step S16), the procedure is terminated without switching the mode (step S20). In a case where the third condition is not satisfied in step S19 (No in step S19), the procedure proceeds to step S20.

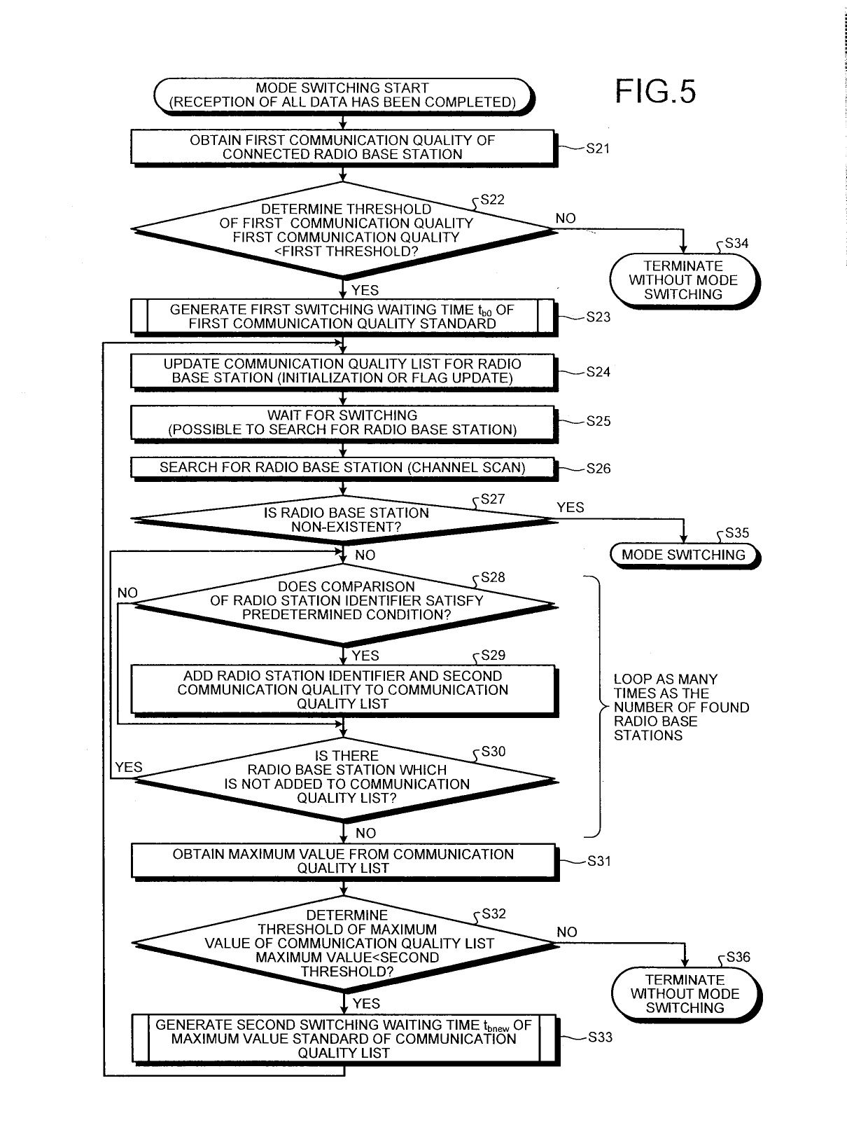

Next, specific examples of the first and second conditions will be described. FIG. 5 is a flowchart of an exemplary determination procedure for mode switching. The communication apparatus 1 in the mode to operate as the terminal starts the determination procedure for the mode switching when all the data have been received. First, the communication quality measurement unit 24 obtains communication quality (referred to as first communication quality below) with the radio base station based on a signal received from the connected radio base station (step S21). Any indexes such as a received signal strength indication (RSSI), received power of the wireless signal, a signal-to-noise power ratio, a communication quality indicator, and a packet error rate may be used as the communication quality. Hereinafter, it is assumed that an index, in which a larger numerical value indicates higher communication quality, is used. In a case where an index in which a larger numerical value indicates lower communication quality is used, a direction of an inequality sign is reversed in a threshold determination relevant to the communication quality to be described below. Instead of performing step S21, the first communication quality, which is obtained during the connection to the radio base station and held, can be used in the processing of step S22 to be described below.

Next, the operation mode setting unit 21 determines whether the first communication quality is lower than a first threshold (step S22). The above-mentioned first condition is whether the first communication quality is lower than the first threshold. When the first communication quality is equal to or higher than the first threshold (No in step S22), the mode is not changed to the mode to operate as the radio base station, and the procedure is terminated (step S34). Generally, in a case where the radio base station to be connected is close to the communication apparatus, the first communication quality is better. In the present embodiment, the terminal close to the radio base station is not changed to the radio base station based on the determination using the first threshold.

When the first communication quality is lower than the first threshold (Yes in step S22), a first switching waiting time t_{b0} based on the first communication quality is generated (step S23). A method of generating the first switching waiting time will be described below. Next, the operation mode setting unit 21 updates a communication quality list of the radio base station (step S24). The update of the communication quality list will be described below. The communication quality list is to store the communication quality with the radio base station other than the connected radio base station (referred to as second communication quality below). Hereinafter, appropriately, the connected radio base station is referred to as a first radio base station, and the radio base station other than the first radio base station is referred to as a second radio base station.

Next, the operation mode setting unit 21 waits for switching during the switching waiting time (step S25). When step S25 is performed through step S33 to be described below, a second switching waiting time to be described below is used as the switching waiting time. When step S25 is performed without going through step S33, the first switching waiting time is used as the switching waiting time. Next, the operation mode setting unit 21 instructs the communication quality measurement unit 24 to search for the radio base station. The communication quality measurement unit 24 thus searches for the radio base station (step S26). Specifically, the communication quality measurement unit 24 determines whether the first notification signal transmitted from the radio base station other than the first radio base station can be received. When the first notification signal can be received, the radio station identifier of the radio base station of a transmission source (second radio base station) and the second communication quality are obtained based on the first notification signal. For example, the communication quality measurement unit 24 performs an operation called channel scan in which the first notification signal is received for each of available frequency bands. During the waiting of step S25, the search for the radio base station in step S26 may be performed.

The operation mode setting unit 21 determines, based on a result of the search for the radio base station, whether the second radio base station is no-existent (step S27). A condition (in a case of YES in step S27) in which there is no second radio base station in step S27 is the above-mentioned second condition. In a case where there is no second radio base station (Yes in step S27), the mode is changed to the operation mode of the radio base station (step S35).

In a case where there is the second radio base station (No in step S27), it is determined whether the radio station identifier of the second radio base station satisfies a predetermined condition (step S28). The predetermined condition is previously defined and held by the operation mode setting unit 21. As a condition in which it is determined that there is the second radio base station (Yes in step S27), a condition can be used in which the first notification signal from the second radio base station cannot be received as a result of the channel scan. Also, when the communication quality measurement unit 24 measures the second communication quality of the first notification signal and the second communication quality is lower than a predetermined threshold (third threshold), that is, when the communication quality is significantly low, it may be determined that the first notification signal cannot be received. Accordingly, influence of the significantly distant second radio base station can be reduced even under a situation where there is a plurality of second radio base stations. The predetermined threshold (third threshold) is smaller than the first and second thresholds.

Here, the setting of the radio station identifier of the present embodiment will be described. In the present embodiment, with the configuration in which the publisher distributes the file to the subscriber via the multicast, the radio station identifier preferably satisfies the following conditions (a) and (b).

(a) The communication apparatus 1 having a possibility to distribute/receive the file using the multicast group can be identified. Hereinafter, the communication apparatus 1 having a possibility to distribute/receive the file using the multicast group is abbreviated as a communication apparatus 1 which can participate in the group.
(b) Between the communication apparatuses 1 having a possibility to distribute/receive the file using the multicast group, the radio station identifier is a value specific for each communication apparatus 1.

First and second allocation methods are used in the present embodiment. The first allocation method is to allocate one identifier satisfying both of the above-mentioned conditions (a) and (b) to the communication apparatus 1. The second allocation method is to allocate one identifier satisfying the condition (a) and one identifier satisfying the condition (b) to the communication apparatus 1. In a case of the first allocation method, for example, upper 1 bit or more of the radio station identifier is set to the same fixed value as an identification bit to the communication apparatus 1 which can participate in the group. Bits other than the fixed value are set to be the specific values for respective communication apparatuses 1. In a case of the second allocation method, for example, the first identifier is set as the same fixed value to the communication apparatus 1 which can participate in the group. The second identifier is set as the specific value for each communication apparatus 1. A specific example of the radio station identifier will be described below. The first notification signal includes the radio station identifier.

The determination as to whether the radio station identifier satisfies the predetermined condition described in step S28 is a determination as to whether the communication apparatus is the communication apparatus 1 which can participate in the group. Therefore, it is determined in step S28 whether the identification bit coincides with the predetermined fixed value when the radio station identifier is allocated by the first allocation method. It is determined in step S28 whether the first identifier coincides with the predetermined fixed value when the radio station identifier is allocated by the second allocation method.

The description returns to FIG. 5. In a case where the radio station identifier satisfies the predetermined condition (Yes in step S28), the operation mode setting unit 21 adds the radio station identifier, the second communication quality corresponding to the radio station identifier, and a update flag for each radio station to the communication quality list (step S29). The update flag for each radio station is a value to determine two values, i.e., True (true) and False (false). False (false) is stored as an initial value. Next, the operation mode setting unit 21 determines whether there is the second radio base station which is not stored in the communication quality list (step S30). In a case where there is the second radio base station which is not stored in the communication quality list (Yes in step S30), the procedure returns to step S28. The procedure after step S28 is performed to the second radio base station which is not stored in the communication quality list.

In a case where there is no second radio base station which is not stored in the communication quality list (No in step S30), the operation mode setting unit 21 obtains the maximum value of the second communication quality from the communication quality list (step S31). At this time, when the update flag for each radio station linked to the radio station identifier in the communication quality list is True (true), the second communication quality of the radio station identifier is excluded in the processing for obtaining the maximum value of the second communication quality. The operation mode setting unit 21 determines whether the maximum value of the second communication quality is smaller than the second threshold (step S32). The above-mentioned third condition is whether the maximum value of the second communication quality is smaller than the second threshold. The second threshold is smaller than the first threshold.

When the maximum value of the second communication quality is equal to or larger than the second threshold (No in step S32), the mode is not changed to the operation mode of the radio base station, and the procedure is terminated (step S36). When the maximum value of the second communication quality is smaller than the second threshold (Yes in step S32), the second switching waiting time t_{bnew} is generated based on the maximum value of the second communication quality (step S33). The procedure then returns to step S24. Also, the procedure proceeds to step S30 when the radio station identifier does not satisfy the predetermined condition (No in step S28).

When the procedure has returned from step S33 to step S24, the communication quality list is updated in step S24. In the update of the communication quality list, either initialization of the communication quality list or an update of the update flag for each radio station is performed. The update of the update flag for each radio station is processing to change all the update flags for respective radio stations of the communication quality list into True (true). The initialization of the communication quality list is to delete the radio station identifier, the second communication quality, and the update flag for each radio station in the communication quality list.

In a case where the procedure has proceeded from step S23 to step S24, the initialization of the communication quality list is performed. In a case where the procedure has proceeded from step S33 to step S24, either the update of the update flag for each radio station or the initialization of the communication quality list is performed. For example, although the update flag for each radio station is usually updated, the communication quality list can be initialized when a certain period of time elapses after performing the previous initialization of the communication quality list or when the initialization of the communication quality list fails to be performed a certain number of times in a row. Accordingly, a terminal during the mode switching can switch the operation mode to a new second radio base station in a case of the transfer or disappearance of the second radio base station. A configuration is available in which the update of the update flag for each radio station is not performed and the initialization of the communication quality list is performed. Accordingly, the propagation can be performed in just proportion, especially in a use case in which the transfer of the second radio base station frequently occurs.

According to the above processing, in a case where the first condition is satisfied (Yes in step S22) and the second condition is satisfied (Yes in step S27) or in a condition where the first condition is satisfied (Yes in step S22) and the second condition is not satisfied (No in step S27), the terminal switches the mode to the radio base station in a case where the second condition is satisfied (Yes in step S27) when the third condition is satisfied (Yes in step S32) and loop processing occurs in which the procedure returns to a second condition comparison again. In the above procedure, the procedure proceeds to the second condition determination processing after waiting for the first switching waiting time in a case where the first condition has been satisfied. However, the procedure may proceed to the second condition determination processing without waiting or after waiting for an arbitrary period of time. Also, in the above procedure, the determination of the second condition is performed regarding the second radio base station in which the determination of the second condition is not performed after the terminal waits for the second switching waiting time in a case where the first and third conditions have been satisfied and the second condition has not been satisfied. In this case, the procedure may proceed to the second condition determination regarding the next second radio base station without waiting for the second switching waiting time or the procedure may proceed to the second condition determination processing regarding the second radio base station after waiting for an arbitrary period of time.

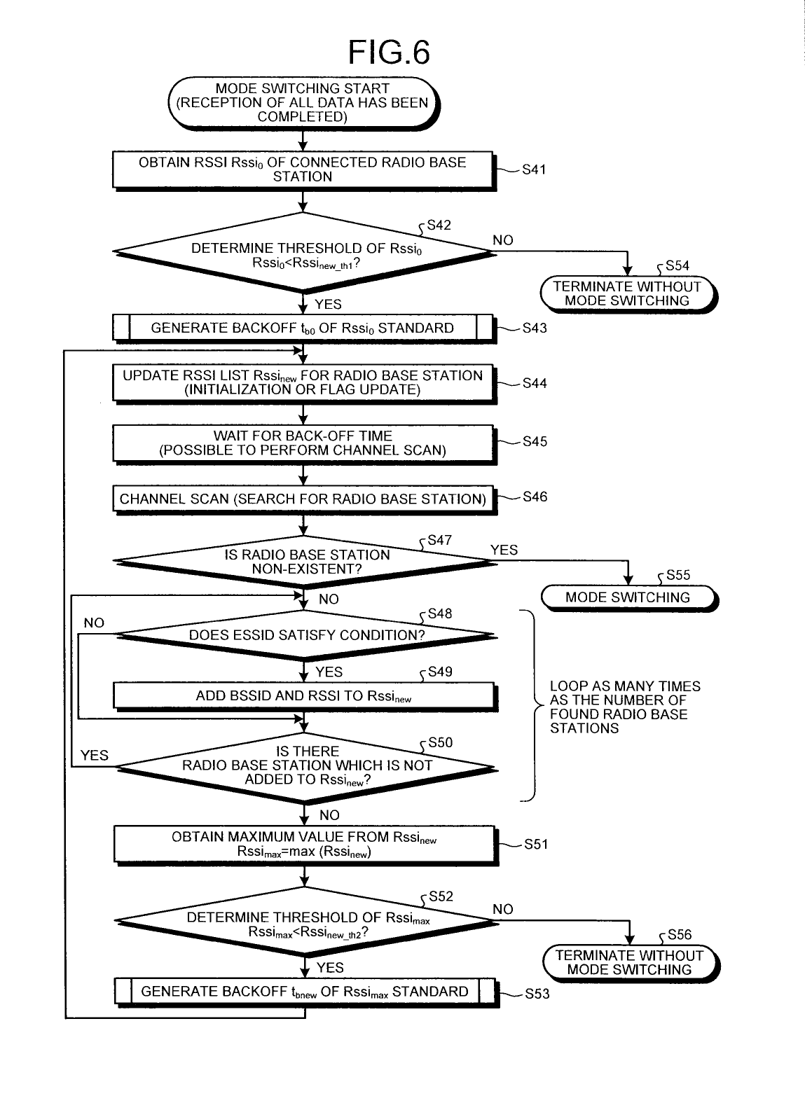

Next, a specific example will be described in which a procedure in FIG. 5 is applied to a wireless LAN system which has complied with the institute of electrical and electronic engineers (IEEE) 802.11. FIG. 6 is a diagram of an exemplary procedure for switching the operation mode to the radio base station in a case of complying with the IEEE802.11. Steps S41, S42, . . . , and S56 in FIG. 6 respectively correspond to steps S21, S22, . . . , and S36 in FIG. 5.

Similar to the example in FIG. 5, the communication apparatus 1 which has determined that all the data have been received starts the determination processing for the mode switching. First, the communication quality measurement unit 24 obtains an RSSI (Rssi₀) as the first communication quality based on the signal received from the connected radio base station (first radio base station) (step S41). Next, the operation mode setting unit 21 determines whether the Rssi₀ is smaller than an Rssi_{new}_{_{—}}ₜₕ₁ which is the first threshold (step S42). In a case where the Rssi₀ is equal to or more than the Rssi_{new}_{_{—}}ₜₕ₁ (No in step S42), the mode is not switched to the radio base station, and the processing is terminated (step S54).

When the Rssi₀ is less than the Rssi_{new}_{_{—}}ₜₕ₁ (Yes in step S42), a backoff (first switching waiting time) t_{b0} based on the Rssi₀ is generated (step S43). Next, the operation mode setting unit 21 updates an RSSI list Rssi_{new} of the radio base station (step S44). The update of the RSSI list Rssi_{new} will be described below.

Next, the operation mode setting unit 21 waits to switch during a back-off time (step S45). Similar to the example in FIG. 5, a back-off time t_{bnew} to be described below is used as the back-off time in a case where step S45 is performed through step S53 to be described below. As the back-off time, the backoff t_{b0} is used when step S45 is performed without going through step S53 to be described below. Next, the operation mode setting unit 21 instructs the communication quality measurement unit 24 to search for the radio base station through the channel scan, and the communication quality measurement unit 24 searches for the radio base station (step S46). Specifically, the communication quality measurement unit 24 obtains the RSSI and the SSID (ESSID and BSSID), which are the second communication quality, based on the beacon frame transmitted from the second radio base station. During the waiting of step S45, the channel scan in step S46 may be performed.

The operation mode setting unit 21 determines, based on the result of searching for the radio base station, whether the second radio base station is no-existent (step S47). When there is no second radio base station (Yes in step S47), the mode is switched to the radio base station (step S55).

In a case where there is the second radio base station (No in step S47), it is determined whether the ESSID of the second radio base station satisfies the predetermined condition (step S48). Here, it is assumed that the ESSID is set to be the same fixed value for the communication apparatus 1 which can participate in the group. Therefore, it is determined whether the ESSID coincides with the fixed value in step S48. A condition where the beacon frame from the second radio base station cannot be received as a result of the channel scan can be used as a condition where it is determined that there is the second radio base station (No in step S47). Also, it may be determined that the beacon frame cannot be received when the communication quality measurement unit 24 measures the RSSI of the beacon frame and the RSSI is equal to or less than the predetermined threshold (third threshold?), that is, when the communication quality is significantly low. Accordingly, influence of the significantly distant second radio base station can be reduced even under a situation where there is a plurality of second radio base stations. The predetermined threshold (third threshold?) is smaller than the first and second thresholds.

The ESSID is a 48-bit address, and a user can freely change the ESSID. The BSSID is a 48-bit address specific for the communication apparatus. Therefore, the ESSID is used as the first identifier described above, and the BSSID is used as the second identifier described above here. However, it is not limited to the example. For example, bits in a predetermined position in the ESSID may be set to the same fixed value, and it may be assumed that the other bits in the ESSID are values specific for respective communication apparatuses. Also, the bits of the predetermined position in the BSSID may be set to be the same fixed value, and it may be assumed that the other bits in the BSSID are values specific for respective communication apparatuses. As a method to determine the value specific for each communication apparatus, for example, a method can be considered in which a random number is generated.

The description returns to FIG. 6. In a case where the ESSID of the second radio base station satisfies the predetermined condition (Yes in step S48), the operation mode setting unit 21 adds the BSSID of the second radio base station, the RSSI corresponding to the BSSID, and the update flag for each radio station to the RSSI list Rssi_{new} (step S49). The update flag for each radio station is a value to determine two values, i.e., True (true) and False (false). False (false) is stored as an initial value. Next, the operation mode setting unit 21 determines whether there is the second radio base station which is not stored in the Rssi_{new} (step S50). When there is the second radio base station which is not stored in the Rssi_{new} (Yes in step S50), the procedure returns to step S48. The processing after step S48 is performed to the second radio base station which is not stored in the Rssi_{new}.

When there is no second radio base station which is not stored in the Rssi_{new} (No in step S50), the operation mode setting unit 21 obtains the maximum value of the RSSI from the Rssi_{new} (step S51). At this time, when the update flag for each radio station linked to the SSID in the communication quality list is True (true), the RSSI of the SSID is excluded in the processing to obtain the maximum value of the Rssi_{new}. The operation mode setting unit 21 determines whether the maximum value of the RSSI is smaller than the second threshold Rssi_{new}_{_{—}}ₜₕ₂ (step S52). The second threshold Rssi_{new}_{_{—}}ₜₕ₂ is smaller than the Rssi_{new}_{_{—}}ₜₕ₁.

When the maximum value of the RSSI is equal to or more than the Rssi_{new}_{_{—}}ₜₕ₂ (No in step S52), the processing is terminated without switching the mode (step S56). When the maximum value of the RSSI is smaller than the Rssi_{new}_{_{—}}ₜₕ₂ (Yes in step S52), the back-off time t_{bnew} which is the second switching waiting time is generated based on the maximum value of the RSSI (step S53). The procedure then returns to step S44. Also, when the ESSID of the second radio base station does not satisfy the predetermined condition (No in step S48), the procedure proceeds to step S50.

When the procedure has returned to step S44 from step S53, the RSSI list Rssi_{new} is updated in step S44. In the update of the RSSI list Rssi_{new}, either initialization of the RSSI list Rssi_{new} or the update of the update flag for each radio station is performed. The update of the update flag for each radio station is processing to change all the update flags for respective radio stations in the RSSI list Rssi_{new} into True (true). The initialization of the RSSI list Rssi_{new} is to delete the SSID, RSSI, and the update flag for each radio station in the RSSI list Rssi_{new}.

In a case where the procedure has proceeded from step S43 to step S44, the RSSI list Rssi_{new} is initialized. In a case where the procedure has proceeded from step S53 to step S44, either the update of the update flag for each radio station or the initialization of the RSSI list Rssi_{new} is performed. For example, although the update flag for each radio station is usually updated, the initialization of the RSSI list Rssi_{new} can be performed when a certain period of time elapses after the previous initialization of the RSSI list Rssi_{new} is performed or when the initialization of the RSSI list Rssi_{new} has failed to be performed a certain number of times in a row. Accordingly, the terminal during the mode switching can switch the operation mode to a new second radio base station in a case of transfer or disappearance of the second radio base station. Also, a configuration is available in which only the initialization of the RSSI list Rssi_{new} is performed without updating the update flag for each radio station. Accordingly, the propagation can be performed in just proportion, especially in the use case in which the transfer of the second radio base station frequently occurs.

According to the above processing, similar to the example in FIG. 5, in a case where the first condition is satisfied (Yes in step S42) and the second condition is satisfied (Yes in step S47), or in a condition where the first condition is satisfied (Yes in step S42) and the second condition is not satisfied (No in step S47), the terminal switches the mode to the radio base station in a case where the second condition is satisfied (Yes in step S47) when the third condition is satisfied (Yes in step S52) and the loop processing, in which the procedure returns to the second condition comparison again, occurs.

Next, the first switching waiting time and the second switching waiting time will be described. The first switching waiting time is generated based on the first communication quality. At this time, the first switching waiting time is generated, so that the smaller the first communication quality, the shorter the first switching waiting time. Accordingly, the operation mode switching of the terminal far from the radio base station has a priority.

Three calculation methods for the first switching waiting time will be mentioned below. The calculation method for the first switching waiting time is not limited to these. The calculation method may be a combination of two or three methods among the three methods below or may be a calculation method other than the methods below.

(Method 1)

The first communication quality is divided into a plurality of ranges, and each range holds a table corresponding to the first switching waiting time. The first switching waiting time is generated with reference to the table. An example of the table will be indicated below.

RSSI<−100 dB: the first switching waiting time=1 second

−100 dB<=RSSI<−90 dB: the first switching waiting time=2 seconds

−90 dB<=RSSI<−80 dB: the first switching waiting time=3 seconds

−80 dB<=RSSI<−70 dB: the first switching waiting time=4 seconds

−70 dB<=RSSI<−60 dB: the first switching waiting time=5 seconds

−60 dB<=RSSI: the first switching waiting time=6 seconds

(Method 2)

The first switching waiting time is calculated by multiplying a coefficient weighted by the first communication quality.

For example, the first switching waiting time is generated by the following formula (1), (2), or (3). An adjustment coefficient is represented by a, and a predetermined time length is represented by time_slot. A function for converting to an integer number is represented by INT ( ). Although the following formulas (1), (2), and (3) are linear expressions relevant to the RSSI, it is preferable to use a calculation formula which monotonically increases relative to the first communication quality without being limited to the linear expression.

The first switching waiting time=RSSI*α (1)

The first switching waiting time=RSSI*α*time_slot (2)

The first switching waiting time=INT(RSSI*α)*time_slot (3)

(Method 3)

The random number depending on the first communication quality is generated, and the first switching waiting time is calculated.

example 1) A random number Rand is generated between Rand_min and Rand_max and is weighted by the RSSI. For example, the first switching waiting time is generated by following formula (4) or (5).

The first switching waiting time=RSSI*α*Rand (4)

The first switching waiting time=RSSI*α*Rand*time_slot (5)

example 2) A range of Rand_min to Rand_max available for the random number Rand is weighted by the RSSI.

When it is assumed that the RSSI is in the range of Rssi_min to Rssi_max, for example, the Rand_rssi is calculated by the following formula (6). The first switching waiting time is generated by the formula (7), (8), or (9) by using Rand_rssi, Rand_min, and Rand_max. Although the following formula (6) is the linear expression of the RSSI, it is not limited to the linear expression in a case of a function which monotonically increases relative to the RSSI. It is assumed that β is a constant number of 0 to 1.

Rand_{—}rssi=(Rand_max−Rand_min)/(Rssi_max−Rssi_min)*(RSSI*−Rssi_min) (6)

The first switching waiting time=RAND(Rand_min,Rand_{—}rssi) (7)

The first switching waiting time=RAND(Rand_{—}rssi,Rand_max) (8)

The first switching waiting time=RAND(Rand_{—}rssi*β,Rand_{—}rssi) (9)

Similar to the first switching waiting time, the second switching waiting time is generated so that the smaller the second communication quality, the shorter the second switching waiting time.

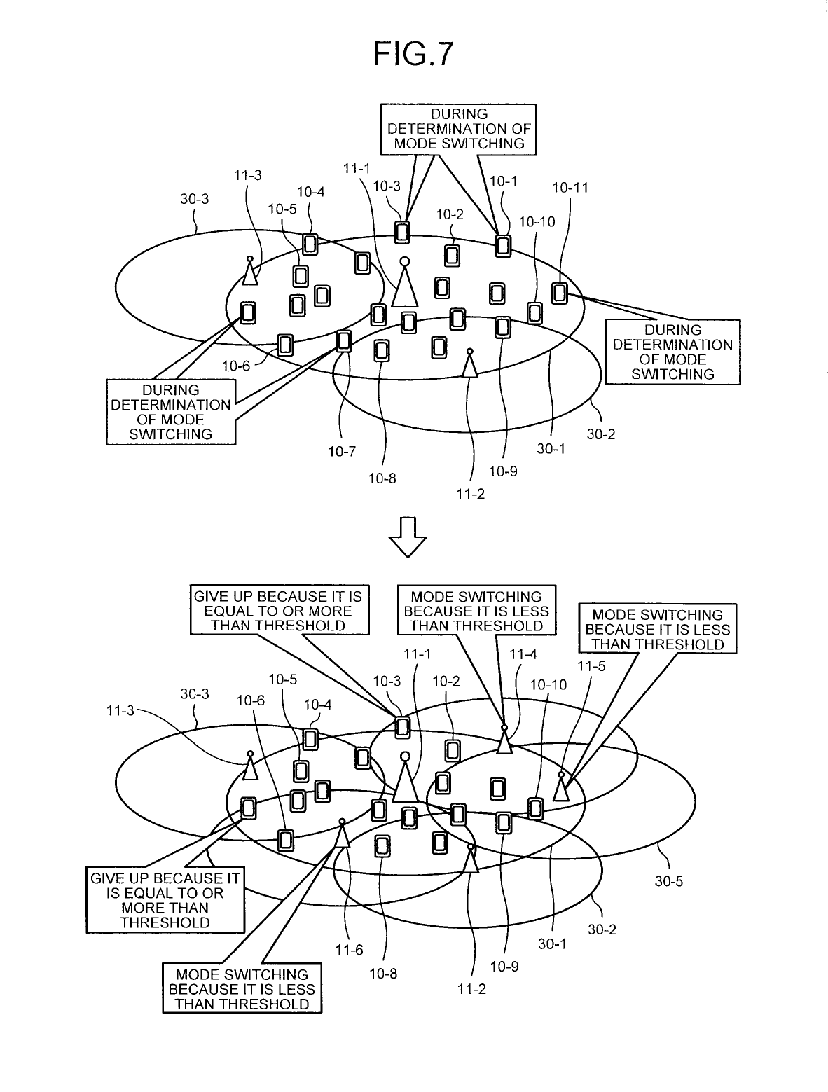

FIG. 7 is a diagram of an exemplary mode switching to the radio base station in a case where there is a plurality of terminals for starting the operation mode switching. FIG. 7 indicates a situation in which there are the terminal for switching the operation mode to the radio base station and the terminal which does not switch the operation mode according to the determination by the first condition. In the upper stage of FIG. 7, three radio base stations 11-1 to 11-3 are in the operation as the radio base stations, and the data is distributed from the radio base station 11-1 to the plurality of terminals. Communication available areas 30-1 to 30-3 indicate areas where the data can be received from the radio base stations 11-1 to 11-3. In order to simplify the diagram, only terminals 10-1 to 10-11 are denoted with reference numerals in FIG. 7. A symbol having the same shape as the terminals 10-1 to 10-11 and having no reference numeral also indicates the terminal. In the upper stage of FIG. 7, the terminals 10-1, 10-3, 10-6, 10-7, and 10-11 out of the plurality of terminals become the terminals for performing the operation mode switching and perform the determination procedure for the mode switching indicated in FIG. 5.

In the lower stage of FIG. 7, the terminals 10-1, 10-7, and 10-11 determine that the first communication quality is less than the threshold (first threshold) according to the threshold determination of the first condition and switch the mode to the radio base station. The terminals 10-1, 10-7, and 10-11 respectively become radio base stations 11-4, 11-6, and 11-5. The terminals 10-3 and 10-6 have the first communication quality equal to or more than the threshold and do not perform the operation mode switching. In this way, the mode is switched when the first communication quality is less than the threshold. Therefore, when there is the plurality of terminals starting the operation mode switching, the number of the radio base stations can be increased and data distribution available range can be expanded while congestion of the radio is avoided.

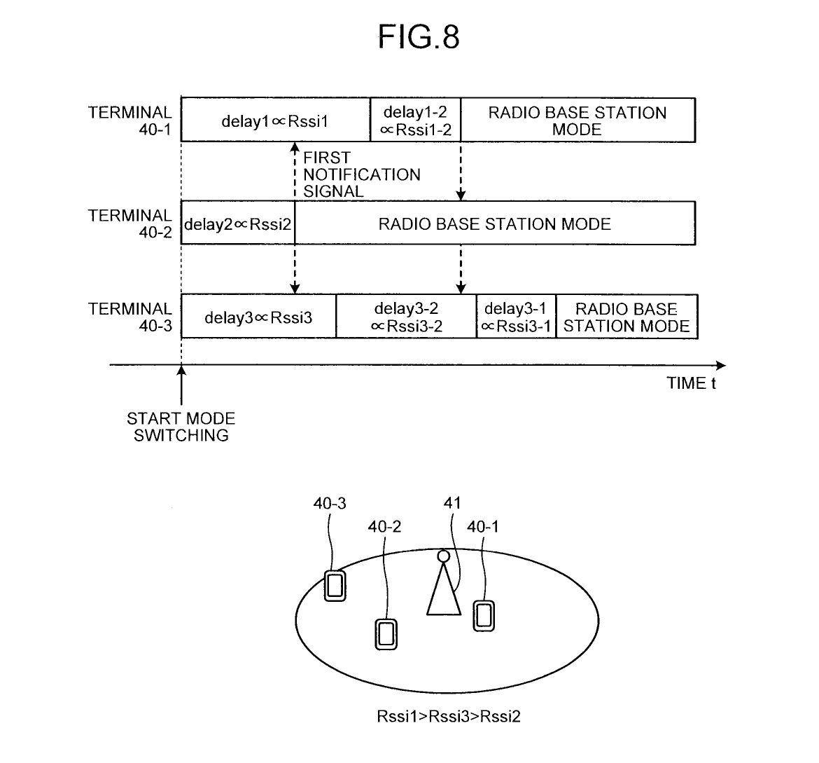

FIG. 8 is a diagram for describing “waiting” of a first switching waiting time and a second switching waiting time. It is assumed that the data reception of a radio base station 41 has been completed and there are three terminals (terminals 40-1, 40-2, and 40-3) performing the operation mode switching as indicated in FIG. 8. It is assumed that the RSSI obtained by the terminal 40-1 based on a signal from the radio base station 41 is Rssi 1 and the RSSI obtained by the terminal 40-2 based on the signal from the radio base station 41 is Rssi 2. It is also assumed that the RSSI obtained by the terminal 40-3 based on the signal from the radio base station 41 is Rssi 3.

In FIG. 8, delay 1 is the first switching waiting time of the terminal 40-1, and delay 2 is the first switching waiting time of the terminal 40-2, and delay 3 is the first switching waiting time of the terminal 40-3. The terminals 40-1, 40-2, and 40-3 enter data sufficient states concurrently with one another. The terminals 40-1, 40-2, and 40-3 search for the radio base station after the respective delays 1, 2, and 3 have elapsed. Since Rssi 1> Rssi 3> Rssi 2 is satisfied in this example, the terminal 40-2 starts to search for the radio base station first. At this point, since there is no other communication apparatus 1 which has switched the operation mode to the radio base station, the terminal 40-2 switches the operation mode to the radio base station. When switching the operation mode to the radio base station, the terminal 40-2 transmits the first notification signal.

The terminals 40-1 and 40-3 search for the radio base station respectively after the delays 1 and 3. The terminals 40-1 and 40-3 obtain the second communication qualities based on a signal received from the terminal 40-2 which has switched the operation mode to the radio base station. It is assumed that the maximum values of the second communication qualities of the terminals 40-1 and 40-3 are equal to or more than the second threshold at this point. The terminals 40-1 and 40-3 generate the second switching waiting time based on the second communication quality. Here, it is assumed that the second communication quality obtained by the terminal 40-1 based on the signal received from the terminal 40-2 which has switched the operation mode to the radio base station is Rssi 1-2. It is assumed that the second communication quality obtained by the terminal 40-3 based on the signal received from the terminal 40-2 which has switched the operation mode to the radio base station is Rssi 3-2. The terminals 40-1 and 40-3 respectively generate the second switching waiting time delay 1-2 and delay 3-2 based on Rssi 1-2 and Rssi 3-2.

It is assumed that delay 1+ delay 1-2 is shorter than delay 3+ delay 3-2. It is assumed that the terminal 40-1 searches for the radio base station after waiting for the delay 1-2 and the maximum value of the second communication quality is less than the second threshold. In this case, the terminal 40-1 switches the operation mode to the radio base station and transmits the first notification signal. It is assumed that the second communication quality obtained by the terminal 40-3 based on a signal received from the terminal 40-1 which has switched the mode to the radio base station is Rssi 3-1. It is assumed that the maximum value of the second communication quality in the terminal 40-3 at this point is Rssi 3-1 and Rssi 3-1 is equal to or more than the second threshold. The terminal 40-3 generates delay 3-1 based on Rssi 3-1 and searches for the radio base station after waiting for the delay 3-1. When it is assumed that the maximum value of the second communication quality is less than the second threshold, the terminal 40-3 switches the operation mode to the radio base station.

It is determined whether the terminal autonomously switches the operation mode to the radio base station based on the communication quality as mentioned above in the present embodiment. Therefore, it is not necessary to obtain permission for the operation mode switching from the connected radio base station, and the terminal can promptly switch the mode to the radio base station when the condition is satisfied. Also, the search for the radio base station is started after the first switching waiting time and the second switching waiting time have elapsed in the present embodiment. However, the search for the radio base station may be performed during the first and second switching waiting. In this case, the operation mode can be switched to the radio base station just after the elapse of the switching waiting time through the second and third conditions, and delay time caused by the search for the radio base station after the elapse of the switching waiting time can be reduced.

Next, a case will be described where the communication apparatus 1 of the present embodiment has a system configuration in which the publisher distributes the file to the subscriber via the multicast.

In the configuration in which the publisher distributes the file to the subscriber via the multicast, generally, the publisher operates as the radio base station and the subscriber operates as the terminal. However, the publisher may operate as the terminal, and the subscriber may operate as the radio base station.

In the transmission/reception of the data between mobile devices, there are circumstances when it is necessary to transmit the same data to the plurality of terminals. In this case, a one-to-many data movement occurs. When communication efficiency is not considered, a method in which one-to-one communication is repeated as many times as the number of the reception terminals can be considered. However, it is redundant to transmit the same data repeatedly. The time to transfer increases, and the frequency band is unnecessarily occupied for a long time.

To avoid this, it is preferable to use one-to-many multicast communication instead of one-to-one unicast communication. In a case where the same data is transmitted to the plurality of other communication apparatuses 1 in the present embodiment, the data transmission/reception is managed by using the multicast group. The multicast group is an assembly of the communication apparatuses 1 which belong to the same logical network and transmit/receive the data to/from each other. In the present embodiment, the logical network includes the plurality of communication apparatuses having the same multicast identifier. That is, the data distributed in the multicast group is transmitted/received between the communication apparatuses having the same multicast identifier. The data distributed in the multicast group is not transmitted/received between the communication apparatuses which do not have the same multicast identifier, even when the communication apparatuses are physically close to each other. In the present embodiment, when the same data is transmitted to the plurality of other communication apparatuses 1, the communication apparatus 1 from which the data is transmitted, that is, the transmission source apparatus is referred to as the publisher (transmission source), and the communication apparatus 1 other than the publisher is referred to as the subscriber (receiver). The subscriber receives the data directly from the publisher or via the other communication apparatus 1. One or more communication apparatuses 1 to be the publishers are set per multicast group.

In a case where the communication apparatus 1 operates as the publisher, the file management unit 22 of the communication apparatus 1 generates the ToC of a file group to be transmitted to the subscriber. The ToC includes an identifier of the file for each file. Also, in a case where the file is divided and transmitted, the ToC includes identification information of the divided data included in the file. A group of data transmitted from the publisher to the subscriber is referred to as “file” in the present embodiment. The file may be any kind of data files. For example, the file may be a text file and may be an image or video data file. The publisher transmits one or more files by a series of messages. The file management unit 22 generates the ToC, in which the information on the file corresponding to the series of messages is stored, before the transmission of the series of messages. In a case where the communication apparatus 1 operates as the publisher, the file management unit 22 generates one or more ToCs and generates an identifier (ID) of the held ToC as ToC Info (ToC information). The message processing unit 23 generates a message (ToC message) in which the ToC information or compressed ToC information is stored. For example, a Bloom filter of the ID of the ToC can be used as the ToC information. The wireless interface 4, for example, periodically informs of the ToC message as the wireless signal.

In a case where the communication apparatus 1 operates as the subscriber, the file management unit 22 holds the list of the files informed by the ToC. Also, when the file is divided and transmitted, the file management unit 22 holds a list of the identification information of the divided data included in the file. The file management unit 22 compares the ToC with the file stored in the non-volatile memory 5 and determines whether all the files mentioned in the ToC have been received. In the present embodiment, a state where the file management unit 22 has received all the files mentioned in the ToC is referred to as “Satisfied”, and the subscriber which has received all the files mentioned in the ToC is referred to as “Satisfied subscriber”. When the state has become Satisfied, the file management unit 22 informs the operation mode setting unit 21 that the state has become “Satisfied”.

In a case where the communication apparatus 1 operates as the publisher, the message processing unit 23 generates a data message for storing the data (data included in the file) held by the non-volatile memory 5. Here, an example in which the publisher transmits the data held by the non-volatile memory 5 to the subscriber will be described. The present embodiment can be applied also when the data received via a wired or wireless line or the data stored in another external storage medium is transmitted.

In a case where the communication apparatus 1 operates as the subscriber, the message processing unit 23 extracts the data from the data message received from the other communication apparatus 1 and stores the data in the non-volatile memory 5. When the ToC has been received, the message processing unit 23 informs the file management unit 22 of a list of the file stored in the ToC (or list of the identification information on the divided data included in the file).

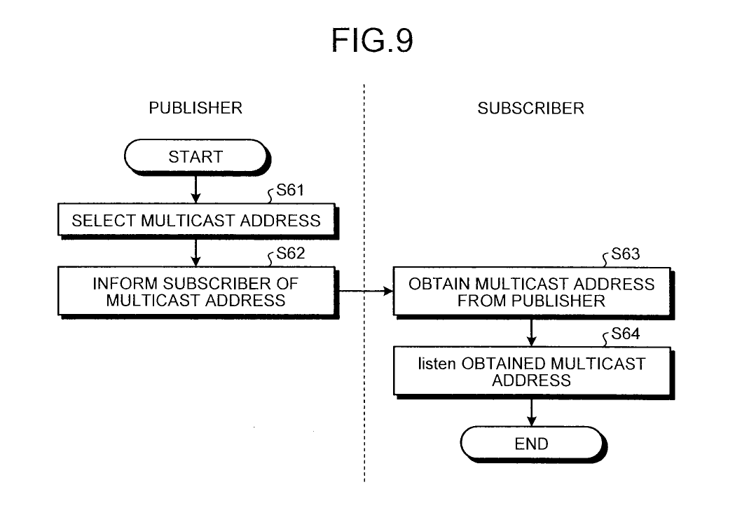

FIG. 9 is a diagram of an exemplary procedure for participating in a multicast group. When a new multicast group is created, the publisher selects a multicast address first (step S61). The multicast group storage unit 3 selects the multicast address. The multicast address is used as an identifier of the multicast group to receive the file transmitted from the communication apparatus 1. Next, the publisher informs an apparatus around itself of the multicast address in some way (step S62). For example, a method and the like can be considered for previously connecting all the communication apparatuses 1 which can participate in the multicast group to a network space having the same network address and for informing the network address via broadcast. Alternatively, a physical method independent from the network may be used such as a method in which an administrator of the publisher orally informs a user of the subscriber of the multicast address. Also, instead of the publisher, an operator may determine the multicast address and set it to the publisher. The operator may inform the user of the multicast address by paper, an e-mail, and the like.

After obtaining the multicast address according to an input by the user or the reception from the publisher (step S63), the subscriber starts listen (data reception transmitted in the multicast group) by setting the multicast address when the file is received from the publisher of the multicast group (step S64). Specifically, the multicast group storage unit 3 of the subscriber holds the multicast address. The multicast group storage unit 3 of the publisher also holds the determined or set multicast address.

As described above, the subscriber participates in the multicast group and starts the reception from the publisher. This is referred to as “associate” in the present embodiment. Also, the subscriber can stop receiving the data from the publisher at a given point in time. In the present embodiment, to stop the data reception from the publisher at a given point in time by the subscriber is referred to as “disassociate”.

When the communication apparatus 1 includes a plurality of wireless interfaces 4, a single communication apparatus 1 may participate in a plurality of multicast groups at the same time. In this case, the multicast addresses set for respective wireless interfaces 4 are different from each other.

The publisher transmits the data message as described above. The publisher transmits a second notification signal to be described below other than the data message. The second notification signal is a ToC message mentioned above.

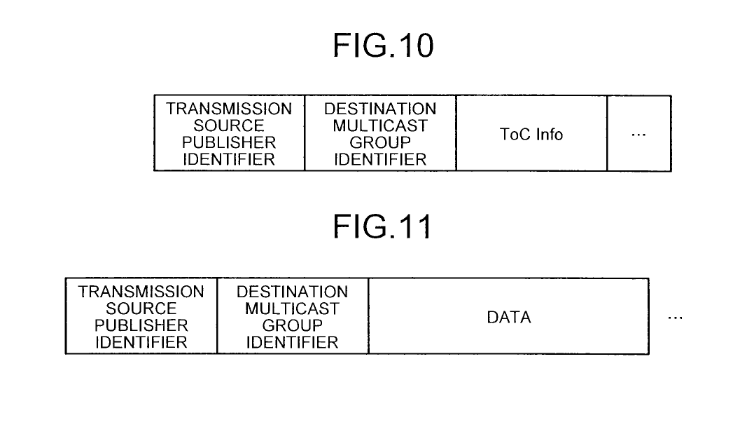

FIG. 10 is a diagram of an exemplary configuration of the second notification signal according to the present embodiment. The second notification signal includes a transmission source publisher identifier, a destination multicast group identifier, and the ToC Info (ToC information). The second notification signal may include information other than these. The publisher transmits the second notification signal and distribution data and the subscriber receives the second notification signal and the distribution data after the terminal is connected to the radio base station. The transmission/reception processing of the first notification signal indicated in FIG. 3 is performed in the data link layer in the OSI reference model. The transmission/reception processing of the second notification signal and the distribution data is performed in a layer upper than the network layer.

Also, the radio station identifier of the first notification signal in FIG. 3 may include information on the ToC message distributed by the publisher. For example, the Bloom filter of the ID of the ToC may be included in a part of the SSID.

FIG. 11 is a diagram of an exemplary configuration of the multicast data message to be transmitted via multicast transmission. The multicast data message stores the transmission source publisher identifier as information indicating the transmission source and the destination multicast group identifier as information indicating the destination as indicated in FIG. 11. Subsequently, data to be transmitted with the data message (data included in the file) is stored.

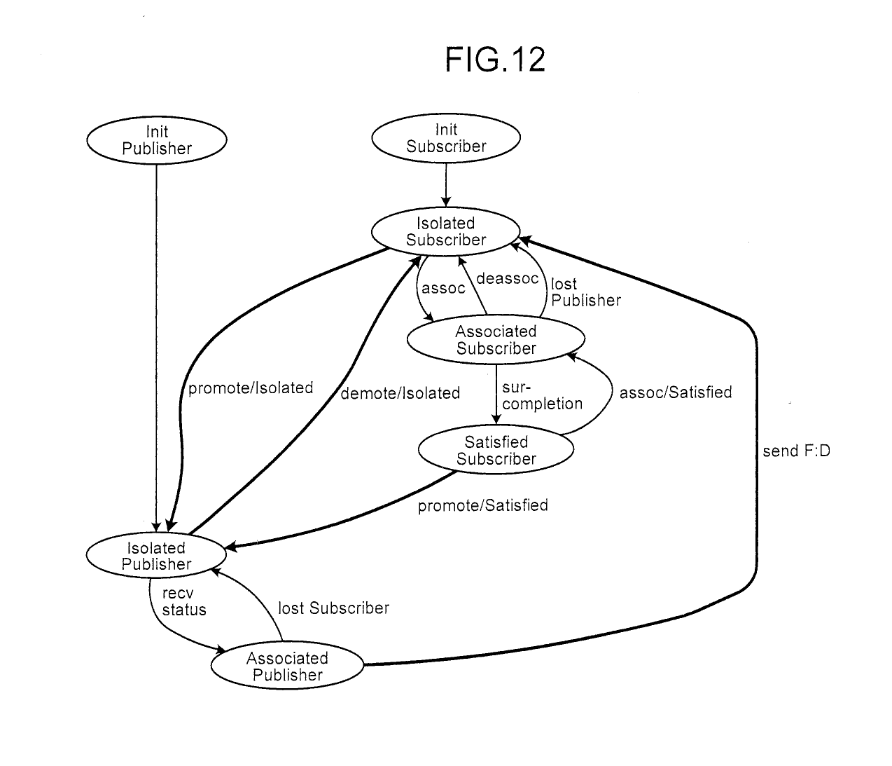

Next, state transition of the present embodiment will be described. FIG. 12 is a diagram of an exemplary state transition according to the present embodiment. The communication apparatus 1 of the present embodiment is set as the publisher or subscriber for each multicast group in an initial state.

For example, one or more publishers are set in the multicast group in the initial state. The subscriber which has received all the data distributed by the publisher includes information equal to that of the publisher. Therefore, such a subscriber can operate as the publisher. When such a subscriber operates as the publisher, the data distribution available range can be increased. On the other hand, even when there is a plurality of publishers close to each other for distributing the same data, it causes the congestion of the radio waves, and efficient data distribution cannot be expected. In the present embodiment, a promotion from the subscriber to the publisher is available, and a restriction to promotion is provided. As a result, the efficient data distribution can be realized while the congestion of the radio waves is avoided.

Here, terms will be described. As a state of the communication apparatus 1 operating as the publisher, three states are defined, i.e., an Init publisher, an Associated publisher, and an Isolated publisher. The Init publisher is a state where the communication apparatus 1 is set as the publisher in the initial state. The communication apparatus 1 in the state of the Init publisher automatically changes to the Isolated publisher. The Isolated publisher is a state where there is no subscriber for receiving the data transmitted by the communication apparatus 1 operating as the publisher. The publisher in the state of the Isolated publisher periodically transmits the first and second notification signals. As will be described below, when the subscriber receives the data from the Associated publisher, for example, the subscriber periodically transmits a status signal to the publisher. The Isolated publisher may transmit the file or does not have to transmit the file. Hereinafter, the communication apparatuses 1 in the respective states are appropriately abbreviated and expressed by using the name of the state. For example, the communication apparatus 1 in the state of the Isolated publisher is appropriately referred to as the Isolated publisher.

The Isolated publisher changes to the Associated publisher by receiving the status signal from the subscriber. The Associated publisher periodically transmits the second notification signal and transmits the file while periodically transmitting the first notification signal. Also, in a case where the Associated publisher does not receive the status signal for a certain period of time or longer (lost subscriber), the Associated publisher determines whether there is another publisher. When there is no other publisher, the Associated publisher changes to the Isolated publisher. The determination as to whether there is another publisher is made, for example, depending on whether the second notification signal from the other publisher is received within a certain period of time.

As a state of the communication apparatus 1 operating as the subscriber, four states are defined, i.e., an Init subscriber, an Associated subscriber, an Isolated subscriber, and a Satisfied subscriber. The Init subscriber is a state where the communication apparatus 1 is set as the subscriber in the initial state. The Init subscriber automatically changes to the Isolated subscriber. The Isolated subscriber is a state where the data is not received from the publisher. The subscriber in the state of the Isolated subscriber receives the second notification signal and receives the data from the transmission source publisher of the second notification signal (to participate in the multicast group corresponding to a multicast identifier stored in the second notification signal) so as to change to the Associated subscriber. The Associated subscriber receives the data from the publisher and stores the received data in the non-volatile memory 5. Also, the Associated subscriber, for example, periodically transmits the status signal to the publisher.

The Associated subscriber can stop receiving the data from the publisher at a given point in time (disassociate). The Associated subscriber changes to the Isolated subscriber by the disassociation. Also, in a case where the Associated subscriber does not receive the signal from the publisher for a certain period of time or longer, the Associated subscriber determines that there is no publisher around, that is, the state becomes a state of a lost publisher. Therefore, the Associated subscriber changes to the Isolated subscriber.

Also, as described above, the Associated subscriber holds the list of the ToC and determines whether all the files included in the list of the ToC have been received and stored in the non-volatile memory 5 (all satisfied). The Satisfied subscriber is in a state of the all satisfied (sur-completion). When the state of the Associated subscriber becomes all satisfied, the Associated subscriber changes to the Satisfied subscriber.

The Satisfied subscriber determines whether the second notification signal from the publisher other than the publisher which has completed the reception can be received. It is assumed that the second notification signal from the publisher other than a first publisher which has completed the reception can be received. In this case, when the Satisfied subscriber determines that a second publisher does not include a file to be transmitted based on the ToC information stored in the second notification signal, the Satisfied subscriber can stop receiving the file from the first publisher and start receiving the data from the second publisher (associate/satisfied). An operation of the Satisfied subscriber will be described in detail below.

The state transition of the subscriber and the state transition of the publisher have been respectively described. As indicated by a bold line in FIG. 12, the subscriber can change to the publisher, and the publisher can change to the subscriber in the present embodiment. In the present embodiment, to change from the subscriber to the publisher is referred to as a promotion to the publisher, and to change from the publisher to the subscriber is referred to as a demotion to the subscriber. The promotion to the publisher can be performed independently of the above-mentioned mode switching from the terminal to the radio base station.

The publisher can become the Isolated subscriber by being demoted at an arbitrary timing. For example, the publisher can be demoted in a case where it is difficult to continue to transmit the data, such as when a battery capacity of the communication apparatus 1 is small. When the Associated publisher is demoted, it is informed that the Associated publisher be demoted. For example, a region to store a flag to inform the demotion is provided in the second notification signal. The demotion may be notified by setting the flag as D(Demotion) by the Associated publisher and transmitting the second notification signal. In a case where the Isolated publisher is demoted, it is not necessary to notify the demotion because there is no subscriber receiving the data. However, the demotion may be notified.

As an example of the promotion, two examples can be considered, i.e., a promotion from the Satisfied subscriber and a promotion from the Isolated subscriber. As a condition of the promotion from the Isolated subscriber, for example, a condition in which the Isolated subscriber is promoted when there is no adjacent publisher can be set. However, the condition of the promotion from the Isolated subscriber is not limited. A condition of the promotion from the Satisfied subscriber to the publisher is not limited. However, the Satisfied subscriber may be promoted to the publisher when the same condition as that of the above-mentioned mode switching from the terminal to the radio base station has been satisfied, for example.

As described above, in the present embodiment, the terminal does not switch the mode to the radio base station in a case where the first communication quality with the first radio base station which is the connected radio base station is equal to or more than the first threshold. The terminal can switch the operation mode to the radio base station when the first communication quality is less than the first threshold and the signal from the second radio base station other than the connected radio base station cannot be received. Also, the terminal does not switch the operation mode to the radio base station in a case where the second communication quality with the second radio base station is equal to or more than the second threshold when the first communication quality is less than the first threshold and the signal from the second radio base station can be received. The determination as to whether there is the second radio base station is repeated again in a case where the second communication quality with the second radio base station is less than the second threshold when the first communication quality is less than the first threshold and the signal from the second radio base station can be received. Therefore, the terminal which has received all the data can autonomously and promptly switch the operation mode to the radio base station. At the same time, it is possible to prevent the terminal close to the radio base station from becoming the radio base station, and the congestion of the radio waves can be avoided. Especially in a case where the radio base station becomes the publisher, it can be avoided that a number of publishers distribute the data via the multicast by avoiding the presence of a number of radio base stations in a close range. Therefore, an effect for suppressing the congestion of the radio waves is large.

Also, when the first communication quality is less than the first threshold, it is determined whether the signal from the second radio base station can be received after waiting for the first switching waiting time generated based on the first communication quality. Accordingly, the terminal far from the radio base station can more quickly change the operation mode to the radio base station. Also, when the second communication quality is less than the second threshold, the re-search for the second radio base station is performed after waiting for a second switching waiting time generated based on the second communication quality. Therefore, the terminal far from the radio base station which has switched the mode from the terminal can more quickly change the operation mode to the radio base station.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication apparatus capable of communicating with an external radio base station, the communication apparatus comprising:
a wireless interface configured to transmit/receive a message to/from outside the communication apparatus;
an operation mode storage unit configured to store an operation mode which shows whether the communication apparatus is in a mode to operate as the radio base station or a mode to operate as a terminal;
a message processing unit configured to generate a message to be transmitted by the wireless interface and to analyze a message received by the wireless interface; and
a non-volatile memory, wherein
the message to be transmitted is output from the wireless interface to the outside of the communication apparatus in a case where the communication apparatus is the radio base station based on the operation mode stored in the operation mode storage unit,
data included in the message received by the wireless interface is stored in the non-volatile memory in a case where the communication apparatus is the terminal based on the mode stored in the operation mode storage unit, and
in a case where the communication apparatus operates as the radio base station, the operation mode is changed from the terminal to the radio base station when communication quality with an external first radio base station is less than a first threshold and a message from a radio base station other than the first radio base station is not received after all the data transmitted by the first radio base station have been received.

2. The communication apparatus according to claim 1, wherein
in a case where the communication quality with the first radio base station is equal to or more than a predetermined value, the operation mode is changed from the terminal to the radio base station when the message from the radio base station other than the first radio base station is not received after waiting for a first switching waiting time.

3. The communication apparatus according to claim 2, wherein
the first switching waiting time is generated based on a first communication quality which is the communication quality with the first radio base station.

4. The communication apparatus according to claim 2, wherein
second communication quality which is communication quality with a second radio base station is obtained in a case where the communication quality with the first radio base station is less than the predetermined value and the message from the second radio base station other than the first radio base station has been received,
it is determined again whether a condition in which the message from the second radio base station is not received is satisfied when a maximum value of the second communication quality is less than a second threshold, and
the operation mode is changed from the terminal to the radio base station when the condition is satisfied.

5. The communication apparatus according to claim 4, wherein
it is determined whether the condition is satisfied after waiting for a second switching waiting time when the maximum value of the second communication quality is less than the second threshold.

6. The communication apparatus according to claim 5, wherein
the second switching waiting time is generated based on the second communication quality.

7. The communication apparatus according to claim 4, wherein
in a case where the communication quality with the first radio base station is less than the predetermined value and the message from the second radio base station other than the first radio base station has been received, the second communication quality is obtained regarding the second radio base station in which a radio station identifier satisfies a predetermined condition out of the second radio base station.

8. The communication apparatus according to claim 4, wherein
the second threshold is smaller than the first threshold.

9. The communication apparatus according to claim 4, wherein
the second communication quality is one of an RSSI, received power of a wireless signal, a signal-to-noise power ratio, a communication quality indicator, and a packet error rate.

10. The communication apparatus according to claim 1, wherein
a first communication quality is one of an RSSI, received power of a wireless signal, a signal-to-noise power ratio, a communication quality indicator, and a packet error rate, the first communication quality being the communication quality with the first radio base station.

11. A communication method for a communication apparatus having a non-volatile memory, the method comprising:
storing an operation mode which shows whether the communication apparatus is in a mode to operate as a radio base station or a mode to operate as a terminal;
outputting a message to be transmitted to outside the communication apparatus in a case where the communication apparatus is the radio base station based on the stored mode;
storing data included in a received message from outside the communication apparatus in the non-volatile memory in a case where the communication apparatus is the terminal based on the stored operation mode; and
changing the operation mode from the terminal to the radio base station when the communication apparatus operates as the radio base station in a case where communication quality with an external first radio base station is less than a first threshold and a message from a radio base station other than the first radio base station is not received after all the data transmitted by the first radio base station have been received.
